(19) United States
(12) Patent Application Publication
(10) Pub. No.: US 2009/0083285 A1
(43) Pub. Date: Mar. 26, 2009

(54) Cross-Satellite memory organization for medical image data

(76) Inventor: Mihaela-Cristina Krause, Erlangen (DE)

Correspondence Address: HARNESS, DICKEY & PIERCE, P.L.C., P.O.BOX 8910, RESTON, VA, 20195, US

(21) Appl. No.: 12/232,084

(22) Filed: Sep. 10, 2008

(30) Foreign Application Priority Data
Sep. 13, 2007 (DE) 10 2007 043 657.4

(51) Int. Cl. G06F 17/30

(52) U.S. Cl. 707/10; 707/E17.032

(57) ABSTRACT

A method, a system and a computer readable medium are disclosed for storing medical image data in a clinic which includes a plurality of satellites as stations. In this arrangement, the image data captured by a modality are all stored in an STS memory and in a long-term storage device. The image data selected as being relevant are stored in a cache which allows rapid access to the data. Hence, a layered memory system with different access times is proposed, wherein the respective satellites and the respective entities are able to interchange data with one another and can also load and store image data from other satellites.

### PRIORITY STATEMENT

The present application hereby claims priority under 35 U.S.C. §119 German patent application number DE 10 2007 043 657.4 filed Sep. 13, 2007, the entire contents of which is hereby incorporated herein by reference.

### FIELD

Embodiments of the invention are based in the field of medical engineering and generally relate to the memory organization for image data in a distributed system which comprises a plurality of clinical facilities which are able to interchange data with one another via a network.

### BACKGROUND

Clinical facilities today usually comprise a multiplicity of departments, subsequently also called satellites, with a complete PACS (Picture Archiving and Communication System) with a modality or with a plurality of modalities for capturing medical image data or other examination data, such as CT, MR, AX etc., and also with memories and databases, and also administration systems.

In a distributed system of this kind (this may be a complex of clinical facilities, for example, with a plurality of satellites which are arranged in a worldwide distribution), a very large volume of data from medical image data is captured, transferred and administrated. This gives rise to great challenges for the memory organization in terms of memory space, on the one hand, and access times, on the other hand.

To date, examination data from a modality have been stored and archived only in specific databases within a satellite. To allow cross-satellite access, an administration and access plane on a higher abstraction level needed to be introduced in the systems known to date in the prior art. This administration plane, which also comprises databases, has been used to administrate matters regarding what examination data can be accessed and are available on what satellites. This has had the drawback that a high level of administration complexity has been necessary in order to allow such cross-satellite access in the first place.

In the prior art, the “SIENET Magic Store System” from the Siemens company is known which comprises a Magic View component and a Magic Store component. These components were always associated with one specific modality, however. All the information relating to examination data was stored and administrated in two databases:
1. in what is known as a patient directory (PDIR), which contains all the examination data records for all the patients (in addition it stored other features relating to a patient, such as a patient name, date of birth, sex, hospital department, patient identification number, etc.)
2. in an image management system database (IMS), which is designed to store image data relating to the examinations. By way of example, this comprises images of patients who are currently being examined or who have recently been examined. To date, search in both databases (IMS, PDIR) has been performed using queries if workstations request particular data records for particular patients.

However, the systems to date do not show a satisfactory result for cross-satellite access to examination data which are filed or stored at various locations in a distributed system and which need to be accessed—particularly for the purpose of diagnosis or analysis—sometimes also very quickly.

### SUMMARY

In at least one embodiment of the present invention, options are improved for accessing examination data which are filed in a distributed multisite system, comprising a plurality of satellites, and for example in at least one embodiment, of providing cross-satellite access at various access speeds and particularly also of speeding up this access.

In at least one embodiment, a method is disclosed for memory organization for medical image data or images in a distributed computer-based system in a clinical facility, comprising a plurality of satellites, wherein a satellite comprises at least one modality for image data capture, a PACS system and at least two local short-term stores with different access speeds, particularly a cache with rapid access and an STS memory with slower access in comparison with the cache, wherein the clinical facility comprises a central database for administrating the stored image data and a central long-term store for long-term storage of image data, the method comprising:
capture of the image data on a modality;
selection of relevant image data from the set of captured image data;
local storage of the relevant image data in the cache;
local replication of all the captured image data in the STS memory;
central replication of all the captured image data in the long-term store;
decentralized, automatic distribution for the purpose of storing the relevant image data to a respective local memory of all the satellites, so that a respective satellite can provide access to remotely captured or stored image data;
   wherein the modality is produced with at least one physical cache and with at least one supplementary functionality which is executed by the modality when a preconfigurable limit load is exceeded for the STS memory locally associated with the modality.

The following text will provide a brief explanation of the terms which have been described or claimed in connection with features of the solution according to embodiments of the invention.

The method relates to memory organization. This is intended to be understood to mean the provision of logical and/or physical memory units (e.g. caches) and of the flow of data from image data having the access options. In principle, all the entities or modules mentioned (such as the cache, the STS memory, the long-term store, the modality, the PACS system, the respective satellites among one another and the respective clients, such as workstations etc.) are connected to one another by means of a network.

The medical images comprise image data and meta data. The meta data are usually stored in a header (e.g. in a DICOM header) and have a reference to the image data (such as age of the patient, health insurance status, etc.). The image data may have been acquired from different modalities and comprise ultrasound images, MRI images, computed-tomography image data, etc.

The clinical facility may be a hospital with various departments or a clinic which has branches in various regions. The departments of the clinical facility are in this case referred to as satellites and comprise a complete medical-engineering infrastructure, such as a PACS system, a data administration system, an administration-management system and memories or memory areas, and also a file server which is intended to store, replicate and/or forward data.

At least one embodiment of the invention preferably provides two local short-term stores, namely a cache and an STS memory. The cache is in the form of a logical memory within the STS memory by virtue of a particular memory area being reserved as a cache in order to allow very rapid access. However, the cache may also be in the form of a separate memory unit. The short-term stores allow access at relatively high access speed, in contrast to the long-term store, which provides a slower access speed.

The modality is a medical-engineering modality for acquiring medical image data, such as a computed tomograph, an MRI unit, an ultrasound unit, etc. In line with one aspect of the invention, the modality is produced with an additional memory entity, particularly with a physical cache. It is likewise possible to link the modality to an additional memory entity.

Replication of image data requires the image data to be stored a plurality of times. They are therefore not merely moved from a first memory location to a second memory location but rather are stored redundantly, which firstly increases the security of the system and secondly can improve the access speeds where the fast memory is being used for the storage. The image data selected as being relevant are distributed for the purpose of storage. Usually, image data captured on one modality are selected as relevant image data, and then only the image data selected as being relevant are automatically distributed to all the satellites. In the satellites, they are respectively stored in a local memory. This is either the cache or—if this is not available or access was erroneous—the short-term store.

In line with another aspect of at least one embodiment of the invention, the modality is produced with at least one supplementary functionality. This preferably includes forwarding or sending image data to other memory areas or entities. In principle, however, all the functionalities which the STS memory provides may also be in the form of a supplementary functionality. The supplementary functionality is executed by the modality when it is established that the STS memory which is associated with the respective modality has exceeded a preconfigurable limit load. In other words, the modality can also perform functions or tasks of the STS memory when the latter is overloaded, e.g. because too many workplaces have applicable requirements with image loading orders. The limit load can be adapted dynamically and is presettable. In the communication between modality and STS memory, meta data are captured which detect a utilization level for the entities involved, particularly for the STS memory.

The way in which embodiments are achieved on the basis of the method is described below. Features, alternative embodiments and/or advantages mentioned in this regard can similarly also be transferred to the other claimed articles, and vice versa. In other words, the material claims can also be developed with the features which are described or claimed in connection with the method. The relevant functional features of the method are in this case formed by appropriate material modules, particularly by software and/or hardware modules, of the system.

At least one embodiment of the invention proposes a layered memory system or memory organization, wherein the respective memories are graded on the basis of their access speeds in order to be able to execute rapid access locally and slower access remotely.

The storage, the replication of the image data and/or the distribution of the relevant image data is/are usually performed by way of a local file server. Alternatively, however, these functions can also be performed by an external entity which is able to interchange data with the satellite's entities which are involved.

A local satellite provides access to remotely stored image data using the central database. In other words, it is possible for a local satellite to provide access not only to the locally filed image data in the respective local memories of the satellite but also to remotely filed image data. By way of example, these may be image data which have been acquired from remote satellites, or they may be image data which have already been filed in the long-term store.

In one development of at least one embodiment of the invention, at least one local short-term store in a satellite, that is to say particularly a local cache or a local STS memory, can be configured as an accumulator, wherein the accumulator is respectively intended to store all the or selected image data for a study and/or image data for a patient from various satellites and/or from various modalities in accumulated form. This accumulator may be in the form of an STS memory, in the form of a cache or in the form of a long-term store. Alternatively, it is also possible not to store the image data per se directly but rather to store merely references to a memory location for the data.

The central database is used to administrate all the meta data for the image data continually. In particular, the meta data comprise a file header for the image data (in the case of the DICOM format, particularly the DICOM header). By way of example, the meta data can be used to derive whether the requested data record is in the cache or in the STS memory in rapidly accessible form or requires slow access to the long-term store. The meta data are preferably analyzed automatically. This feature has the advantage that the image data can be accessed in optimum time.

The criteria which are used to delete the image data from the short-term stores, that is to say from the cache and from the STS memory, can be configured. These criteria are deletion criteria which can be modified adaptably in the individual case. Preferably, the image data are respectively set to be stored in a short-term store for six months. In addition, the image data are archived as early as possible, likewise in the long-term store. As such, there may be a resultant overlap time for storage of the data in the long-term store and in the short-term store of no more than six months. Alternatively, other times or events can also be set in this case.

In line with another aspect of at least one embodiment of the invention, it is likewise possible to configure what criteria are used for long-term storage in the long-term store (LTS). These long-term storage criteria can likewise be configured. The configuration options just mentioned allow the flexibility of the solution according to at least one embodiment of the invention to be increased.

To be able to keep the volume of data to be transmitted for the image data as small as possible, all the image data are not distributed to all the satellites as a basic principle, but rather only the image data selected as being relevant are distributed. In other words, only the relevant image data within the clinical facility are distributed to the other satellites.

Relevant image data are selected automatically. This is done particularly by means of analysis of a file header for the image data. Alternatively or cumulatively, it is possible to use other indices. By way of example, there may be a setting such that, as a basic principle, a file is identified as being relevant and is selected when a treating doctor has added a note to the file (e.g. in the form of an arrow pointing to a particular region of the body etc.) or has made other changes to the data.

Preferably, the cache is in the form of a logical cache and/or is arranged within the STS memory. This has the advantage that the existing STS short-term store does not need to be modified in order to implement the solution according to at least one embodiment of the invention. A particular memory area in the existing STS memory is merely reserved as a cache. Alternatively, however, it is also possible to incorporate an additional memory module.

In one development of the invention, the modality is additionally equipped with a further memory module, namely with a physical cache, in order to be able to access image data with short access times. This feature is found to be advantageous particularly when the modality is also intended to perform other functions of the STS memory if the latter is overloaded by a large number of orders.

Another aspect of at least one embodiment disclosed is a system for storing medical images in a computer-based clinical facility which comprises a plurality of satellites, wherein a satellite at least comprises
a modality for capturing the image data,
a PACS system for administrating and managing data, and
two local short-term stores, particularly a cache and an STS memory, and wherein the clinical facility comprises the following:
a central database for administrating the stored image data,
a central long-term store for long-term storage,
a file server which stores, replicates and/or forwards the image data captured by the modality, and
a selection module which is intended to select relevant image data from the set of captured image data;
   wherein the file server is intended to store the image data captured as being relevant by the selection module locally in the cache and to replicate all the image data captured by the modality locally in the STS memory and to replicate all the image data captured by the modality centrally in the long-term store and automatically distributes the image data captured as being relevant by the selection module in decentralized fashion to all the other satellites, particularly to the respective local memories of the respective satellites, so that a respective satellite is able to access remotely captured or stored image data, wherein the modality is produced with at least one supplementary module, wherein the supplementary module is executed in the modality when a particular functionality cannot be executed in the STS memory locally associated with the modality because the STS memory has exceeded a preconfigurable limit load, wherein the supplementary module is intended to execute an additional functionality.

It is further clear that a person skilled in the art understands that data interchange is provided between all the modules involved and in particular between the satellites.

In one advantageous development, the system may additionally comprise an accumulator which is in the form of a cache or in the form of an STS memory.

In line with one aspect of at least one embodiment of the invention, the modality of the system is additionally produced with a physical cache which allows rapid access to local image data.

It should once again be pointed out at this juncture that the aspects and features mentioned, described or claimed in connection with the method can similarly be used in the system, in the computer program product and/or in the storage medium, the functionalities being produced by appropriate modules which are intended to execute the relevant functionality.

The inventive embodiments of the method which are described above may also be in the form of a computer program product, wherein the computer is prompted to carry out the inventive method described above and the program code thereof is executed by a processor.

In line with another aspect of at least one embodiment of the invention, a storage medium is disclosed which is intended to store the computer-implemented method described above and can be read by a computer.

### BRIEF DESCRIPTION OF THE DRAWINGS

The detailed description of the figures which follows discusses example embodiments, which are to be understood as nonlimiting, with their features and further advantages with reference to the drawings, in which:

FIG. 1 shows a synoptic illustration of modules with associated memory units in line with one example embodiment of the invention, and

FIG. 2 shows a schematic illustration of image data being split into relevant and nonrelevant image data and the storage or archiving thereof in various memory units.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term. such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

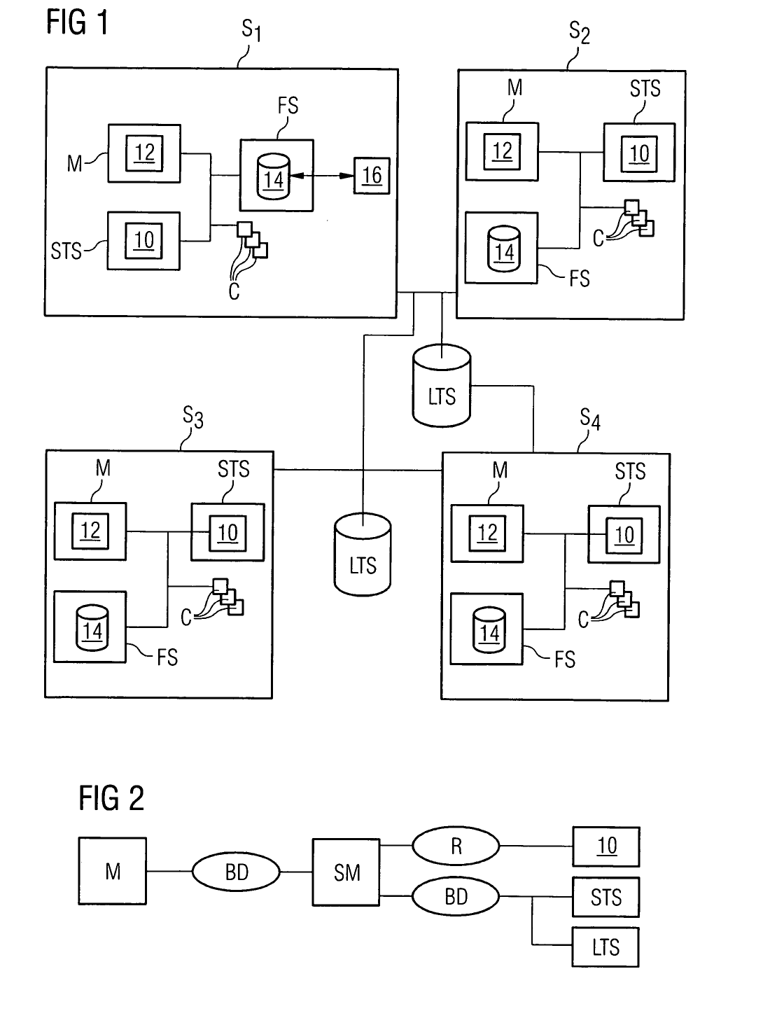

FIG. 1 shows the schematic design of a clinical facility which comprises a multiplicity of satellites S. FIG. 1 shows four satellites S₁, S₂, S₃ and S₄, the first satellite S₁ being intended to denote the main site.

A satellite S comprises at least one modality M for acquiring the image data which, in line with one aspect of the invention, is equipped with a physical cache 12. In addition, the satellite S comprises an STS memory as a short-term store which comprises a logical cache 10. A file server FS has the primary task of providing memory space for relatively large volumes of data (particularly image data BD) and of allowing a plurality of users to access these data via a network. The file server comprises hardware (e.g. in the form of hard disks) in combination with software which regulates access modalities. In the main site, a local database 14 which is associated with the file server FS communicates with a central data administration 16 (or with a central data administration unit). The aforementioned units of the satellite S₁ have a multiplicity of clients C connected to them. Alternative implements of a satellite S also provide additional modules here, such as an image data management (IDM) system and an administration management (operation management—OPM). All the satellites S have access to a central database (not shown in the figures). The memory system for long-term storage LTS may also be replaced by an NAS (Network Attached Storage) system for cross-satellite archiving of image data.

In FIG. 1, the long-term store LTS is arranged at a central location and communicates with the respective connected satellites S. In addition, the respective satellites S are able to interchange data with one another. The respective satellites are produced with clients C on them which access the image data BD.

As FIG. 1 shows, the short-term store comprises a cache 10, 12 and an STS memory STS. The STS memory STS comprises a logical cache 10. Preferably, the logical cache 10 is reserved as a memory area for rapid access in the STS memory STS. In addition, the modality M comprises a physical cache 12, which may be arranged as an internal module within the modality M or which is switched in as a separate memory entity of the modality M as required.

The cache 10, 12 has a limited, configurable memory size. If the volume of data to be stored in the cache 10, 12 exceeds a predefinable threshold limit, provision may be made for the respective entries to be stored in the STS memory STS and possibly deleted from the cache 10, 12. Alternatively or cumulatively, it is possible to provide particular deletion criteria here which are taken as a basis for deleting the data records in the cache 10, 12. The deletion criteria may be event-dependent (e.g. to avoid memory overflow) or time-dependent (e.g. storage time). At any rate, the deletion criteria are configurable or can be adapted to suit the respective case.

FIG. 2 is intended to schematically show an inventive flow of data based on a preferred embodiment. The data are captured by the modality M as image data BD. This is followed by a selection module SM which filters the relevant image data R from the set of image data BD. Next, the relevant image data R are processed separately from nonrelevant image data. The relevant image data R are stored in the logical cache 10, while the complete set of captured image data BD is filed in the STS memory STS and in the long-term store LTS. This feature firstly allows a significant increase in performance to be achieved. On the other hand, security conditions are satisfied to the extent that, in principle, all the images are stored in the long-term store as quickly as possible.

The provision of a logical cache 10 on every STS store STS on every satellite S allows rapid access to the image data BD to be ensured within a clinical facility. In addition, the system proposed here is less susceptible to error when a hospital department or a satellite S is unavailable, since the respective other satellites S have stored at least some of the captured image data BD. As soon as any changes are made to the image data (text input, new descriptor, indexing of particular areas of the body by adding arrows, etc.) or as a result of a change of memory location, these data are immediately filed as meta data in a central database and are available to all the satellites S. The central database captures all the meta data for the whole clinical facility, that is to say from all the satellites S.

The production of a physical cache 12 on the modality M allows the images to be loaded more quickly on the respective workstations/clients C. The file server FS or another entity first of all, following receipt of a loading order for a particular image data record BD, analyzes whether the respective requested image data BD are in the cache 10, 12 or in the STS memory STS. If this is the case, the image data BD are picked off from the “rapid” memories. Otherwise, they need to be retrieved from slower memory units, particularly from the long-term store LTS.

Since, in line with one aspect of at least one embodiment of the invention, the modality M performs a supplementary functionality and can therefore also perform functions of the STS memory STS, it may be that parallel loading of image data BD can be used to significantly reduce the loading time. By way of example, the modality M can load a first half of requested image data BD while the short-term store STS takes the second half of the image data which are to be loaded. This makes it possible to remedy overloading the STS memory STS, which can arise if too many clients C are sending image loading orders, for example.

In line with one aspect of at least one embodiment of the invention, provision is thus made for the network load and the load on the individual modules (particularly the modality M and the memories STS, 10, 12) to be analyzed and the load limits to be monitored by means of a watchdog. If a load limit has been exceeded for a module, the current order can be distributed over the other modules. In particular, image data BD can be loaded and stored partly by the STS memory STS and partly by the modality M. Provision is made for data interchange between the clients C, the modality M and the STS memory STS. If it is assumed, by way of example, that a client C has issued a loading order to load image data BD for an examination, with the examination comprising 1000 images, for example, then it is possible for the modality M to start the data transmission upon the 1000th image, and then to proceed decrementally with the 999th image, the 998th image, the 997th image, until it has reached the middle. At the same time, the STS memory STS starts incrementally sending the first, second, third etc. image. This allows a significant increase in the transfer rates.

In principle, all the meta-data, which also comprise a memory location for the respective data, are filed in a central database. Another option is to replicate the meta data on all the satellites S. At any rate, it must be ensured that a respective site or a respective satellite S has stored all the current addresses at which all the image data BD are available within the clinical facility. If new data are captured on a satellite S, all the other satellites S are informed of this.

In conclusion, it should be pointed out that the description of the invention and the example embodiments are, in principle, intended to be understood to be nonlimiting in respect of a particular physical implementation of the invention. In particular, it is obvious to a person skilled in the relevant art that embodiments of the invention can be implemented partly or completely in software and/or hardware and/or in a manner distributed over a plurality of physical products—in this case particularly also computer program products.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for storing medical image data in a distributed computer-based system in a clinical facility, including a plurality of satellites, wherein a satellite includes at least one modality, an image-processing, image-administration and archiving system and at least two local short-term storage devices with different access speeds, and wherein the clinical facility includes a central database for administrating the stored image data and a central long-term storage device for long-term storage, the method comprising:
capturing the medical image data on the at least one modality;
selecting relevant image data from the set of captured medical image data;
locally storing the selected relevant image data in at least one of the short term storage devices;
locally replicating all the captured image data in at least one other of the short term storage devices;
centrally replicating all the captured image data in the central long-term storage device;
automatically distributing, in a decentralized manner, the relevant image data to a respective local memory of all the satellites, wherein the modality is produced with at least one physical cache and with at least one supplementary functionality which is executed by the modality when a preconfigurable limit load is exceeded for the at least one other of the short term storage devices locally associated with the modality.

2. The method as claimed in claim 1, wherein at least one of the storage, the replication of the image data and the distribution of the relevant image data is performed by way of a local file server.

3. The method as claimed in claim 1, wherein the central database is used to provide access to remotely stored image data from a local satellite, and wherein only the image data selected as relevant are distributed to all the satellites in the clinical facility.

4. The method as claimed in claim 1, wherein at least one local short-term storage device in a satellite is configurable as an accumulator, and wherein the accumulator is respectively intended to store at least one of all the and selected image data for a study from at least one of various satellites and various modalities in accumulated form.

5. The method as claimed in claim 1, wherein the central database is used to administrate all the meta data for the image data continually in order to ensure that the image data are accessed in optimum time.

6. The method as claimed in claim 1, wherein deletion criteria is configurable which are used to delete the image data from at least one of the short term storage devices.

7. The method as claimed in claim 1, wherein long-term store criteria is configurable which are used for long-term storage of the image data in the long-term storage device.

8. The method as claimed in claim 1, wherein relevant image data are selected automatically.

9. The method as claimed in claim 1, wherein at least one of the short term storage devices is a cache.

10. The method as claimed in claim 9, wherein the modality is produced with a physical cache.

11. A system for storing medical images in a computer-based clinical facility which includes a plurality of satellites, wherein a satellite includes:
a modality for capturing the image data,
a PACS system for administrating and managing data, and
at least two local short-term storage devices, the system comprising:
a central database for administrating the stored image data;
a central long-term storage device for long-term storage;
a file server to at least one of store, replicate and forward the image data captured by the modality; and
a selection module to select relevant image data from the set of captured image data,
wherein the file server is intended to store the image data captured as being relevant by the selection module locally in one of the at least two local short-term storage devices and to replicate all the image data captured by the modality locally in one other of the at least two local short-term storage devices and to replicate all the image data captured by the modality centrally in the long-term storage device and automatically distribute the image data captured as being relevant by the selection module in decentralized fashion to all the other satellites so that a respective satellite is able to access remotely captured or stored image data, wherein the modality is produced with at least one supplementary module, and wherein the supplementary module is executed in the modality when a particular functionality cannot be executed in the other of the at least two local short-term storage devices locally associated with the modality because the other of the at least two local short-term storage devices has exceeded a preconfigurable limit load, wherein the supplementary module is intended to execute this functionality.

12. A computer readable medium including program segments for, when executed on a computer device, causing the computer device to implement the method of claim 1.

13. The method as claimed in claim 2, wherein the central database is used to provide access to remotely stored image data from a local satellite, and wherein only the image data selected as relevant are distributed to all the satellites in the clinical facility.

14. The method as claimed in claim 8, wherein relevant image data are selected automatically on the basis of analysis of meta data.

15. The method as claimed in claim 8, wherein relevant image data are selected automatically on the basis of analysis of a file header for the image data.

16. The method as claimed in claim 1, wherein at least one of the short term storage devices is a cache and at least one other of the short term storage devices is an STS memory.

17. The method as claimed in claim 16, wherein the cache is a logical cache in the STS memory.

18. The system as claimed in claim 11, wherein at least one of the short term storage devices is a cache and at least one other of the short term storage devices is an STS memory.
